(19) United States
(12) Patent Application Publication
(10) Pub. No.: US 2023/0420807 A1
(43) Pub. Date: Dec. 28, 2023

(54) BATTERY ASSEMBLY

(71) Applicant: Battery Graphene Corp Pty Ltd, Queensland (AU)

(72) Inventor: Dominic SPOONER, Queensland (AU)

(21) Appl. No.: 18/462,988

(22) Filed: Sep. 7, 2023

Related U.S. Application Data
(63) Continuation-in-part of application No. PCT/AU2022/050096, filed on Feb. 14, 2022.

(30) Foreign Application Priority Data
Mar. 12, 2021 (AU) 2021101290

(51) Int. Cl. H01M 50/503; H01M 50/516; H01M 50/271; H01M 50/213

(52) U.S. Cl. CPC H01M 50/503; H01M 50/516; B60L 50/64; H01M 50/213; H01M 50/271

(57) ABSTRACT

The present invention relates to a battery assembly. The assembly includes batteries. Posts extend from the batteries. A receiver receives the posts, and a locking member engages with the received posts to lock the assembly together. Advantageously, the locking member may require less pressure to lock the assembly together and may be easier to release than the snap fit arrangement of PCT/AU2020/050604, without the need for screws or other threaded fasteners.

### CROSS-REFERENCE TO RELATED APPLICATION

The present application is a continuation-in-part of PCT International Application No. PCT/AU2022/050096, filed on Feb. 14, 2022, which claims priority to Australian Provisional Application No. 2021101290, filed Mar. 12, 2021. Each of the foregoing applications is incorporated by reference herein in its entirety.

### TECHNICAL FIELD

The present invention relates to a battery assembly.

### BACKGROUND

The reference to any prior art in this specification is not, and should not be taken as an acknowledgement or any form of suggestion that the prior art forms part of the common general knowledge.

Battery clamshells are a type of battery assembly commonly used in electric vehicles. The clamshell includes batteries with welded tabs at top and bottom. Plastic layers are provided to hold the batteries and a serpentine cooling system runs though the clamshell.

PCT/AU2020/050604 discloses a less complex battery assembly which avoids the need to weld by enabling snap fitting of parts during assembly. The snap-fitting involves squeezing resilient heads through apertures. However, in practice, significant force is required to snap fit the parts together, particularly for larger assemblies with a greater number of cells. Furthermore, it can be difficult to release the parts of the assembly for recycling.

The present invention provides an improved battery assembly.

### SUMMARY OF THE INVENTION

According to one aspect of the present invention, there is provided a battery assembly including:
batteries;
posts extending from the batteries;
a receiver for receiving the posts; and
a locking member for engaging with the received posts to lock the battery assembly together using a tongue-in-hole arrangement for engaging the locking member with the posts.

Advantageously, the locking member may require less pressure to lock the assembly together and may be easier to release than the snap fit arrangement of PCT/AU2020/050604, without the need for screws or other threaded fasteners.

The locking member may define apertures through which respective posts pass. The locking member may engage with the posts using a tongue-in-hole arrangement. The locking member may be slid along the receiver to engage the tongue-in-hole arrangement for locking. The locking member may define tongues in the apertures which engage within holes in the posts.

The receiver may define apertures through which respective posts are received. The receiver may include an insulator plate. The receiver may include a current collector for engaging with the batteries.

The battery assembly may further include a base plate. The base plate may include an insulator plate. The base plate may include a current collector for engaging with the batteries. The posts may extend from the base plate. The posts may be welded to the base plate.

According to another aspect of the present invention, there is provided a battery pack including:
the assembly; and
a casing for encasing the assembly.

The casing may include a container, and a lid for fitting to the container.

According to one aspect of the present invention, there is provided a retainer for retaining batteries in a battery assembly, the retainer including:
posts for extending from the batteries;
a receiver for receiving the posts; and
a locking member for engaging with the received posts to lock the battery assembly together using a tongue-in-hole arrangement for engaging the locking member with the posts.

According to another aspect of the present invention, there is provided a method for assembling a battery assembly, the battery assembly including batteries and posts extending from the batteries, the method including:
receiving the posts with a receiver; and
engaging a locking member with the retained posts to lock the battery assembly together using a tongue-in-hole arrangement for engaging the locking member with the posts.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of a battery assembly in an open position with a locking plate removed;

FIG. 2 is a perspective view of the battery assembly of FIG. 1, with the locking plate in an unlocked slide position;

FIG. 3 is a perspective view of the battery assembly of FIG. 2, with the locking plate slid to lock the assembly together;

FIG. 4 is a perspective view of the base of the battery assembly of FIG. 1; and

FIG. 5 is a perspective view of the battery assembly of FIG. 1 showing all of the layers.

### DETAILED DESCRIPTION OF PREFERRED EMBODIMENTS

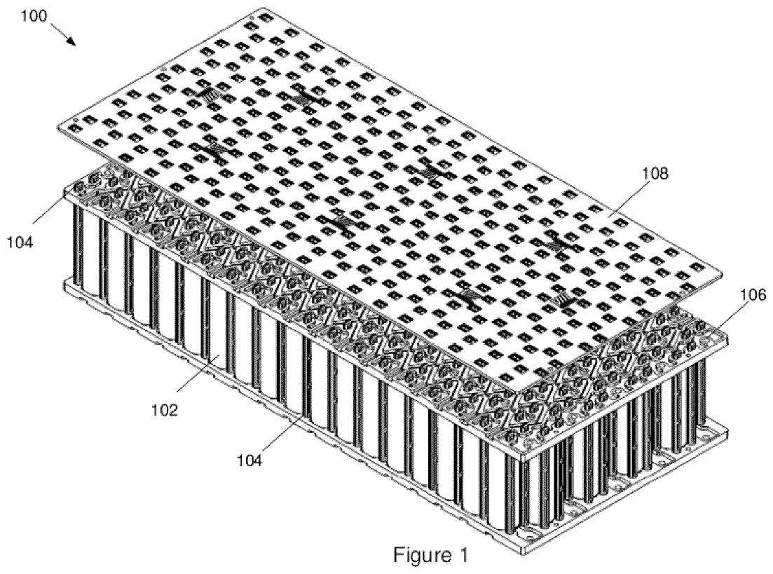

According to an embodiment of the present invention, there is provided a battery assembly 100 as shown in FIG. 1.

The battery assembly 100 includes a grid of cylindrical batteries 102, each standing upright. Posts 104 extend up from the top of the batteries 102. A plate receiver 106 is provided for receiving and retaining the upper free ends of the posts 102 in position during locking. The receiver 106 defines apertures through which respective posts 102 are snugly received.

A locking plate 108 (i.e. member) is provided for engaging with the retained posts 104, which then resist bending and lateral movement, to lock the assembly 100 together. Advantageously, the locking plate 108 requires less pressure to lock the assembly 100 together and is easier to release than the snap fit arrangement of PCT/AU2020/050604, also without the need for screws or other threaded fasteners.

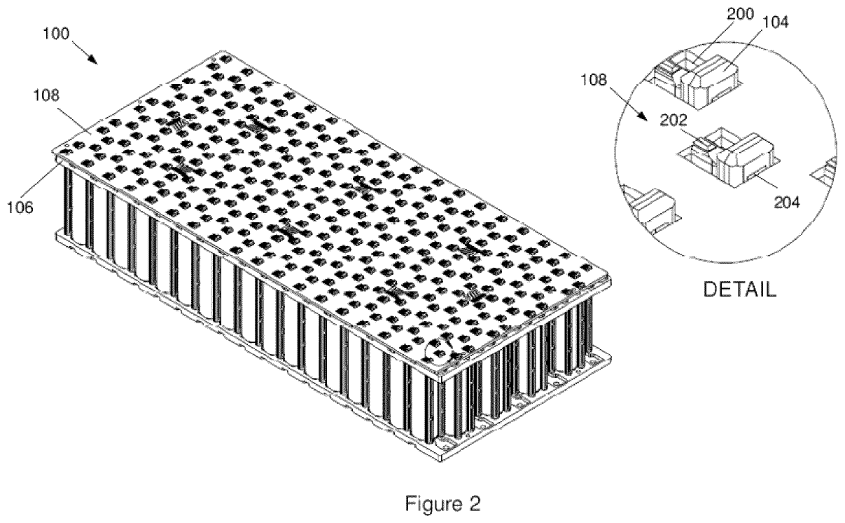

Turning to FIG. 2, the locking plate 108 defines apertures 200 through which the free end of respective posts 104 pass. The locking plate 108 engages with the posts 104 using a tongue-in-hole arrangement. The locking plate 108 defines tongues 202 in the apertures 200 which engage within holes 204 in the posts 104.

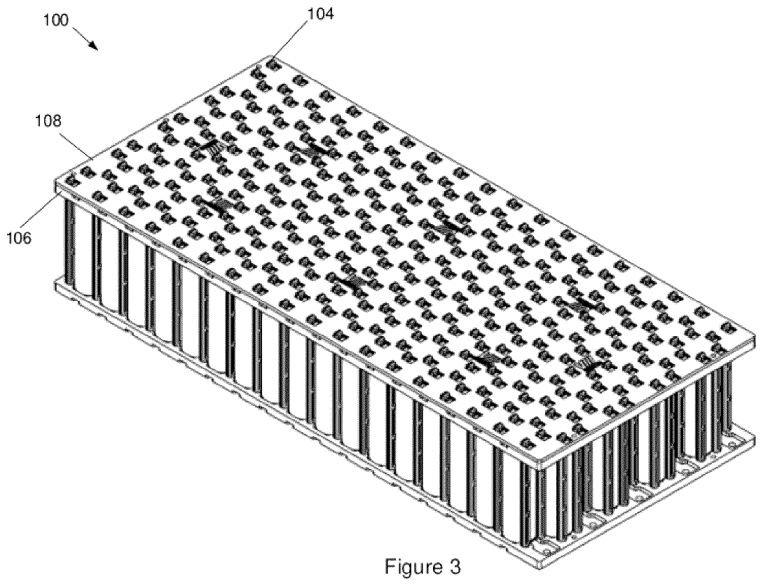

As can best be seen in FIG. 3, the locking plate 108 is slid along the plate receiver 106 to engage the tongue-in-hole arrangement for locking when the locking plate 108 and receiver 106 are superposed.

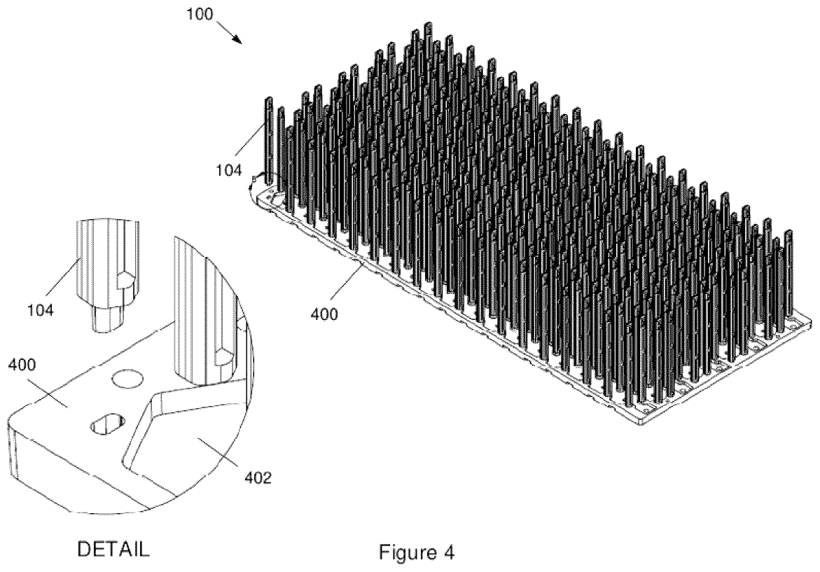

Turning to FIG. 4, the battery assembly 100 further includes a base plate 400. The polymeric posts 104 extend perpendicularly from the base plate 400. The resilient posts 104 are inserted into the base plate 400, and then electro-welded to the base plate 400. The base plate 400 defines a receiver 402 for receiving a current collector which contacts the batteries 102.

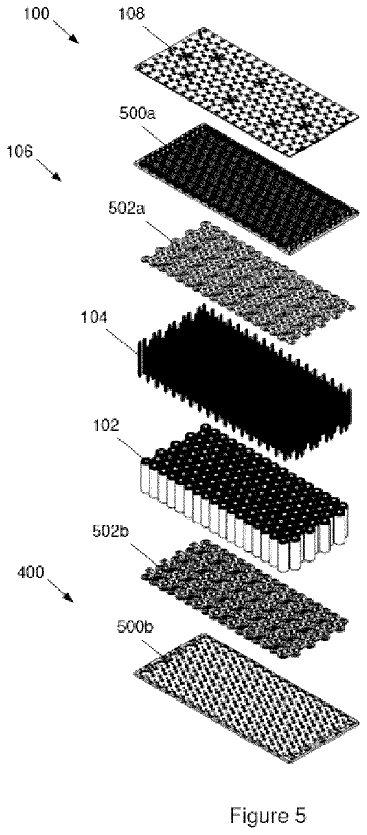

Turing to FIG. 5, the receiver 106 includes an outer insulator plate 500a, and an adjacent inner current collector 502a for engaging with the batteries 102. The current collector 502a and batteries 102 are received within the outer insulator plate 500a.

Similarly, the base plate 400 includes an outer insulator plate 500b, and an adjacent inner current collector 502b for engaging with the batteries 102. The current collector 502b and batteries 102 are received within the receiver 402 of the outer insulator plate 500b.

The electrical insulator plates 500, posts 104 and locking plate 108 are molded from polymeric material to avoid short circuiting the batteries 102, and include graphene to enhance thermal conductivity for heat sinking. The electrically conductive current collectors 502 are coated within respective insulator plates 500, and include metal and graphene. The current collectors 502 can be configured so that the batteries 102 are connected in parallel or series, as required.

The assembly 100 can be snugly encased withing a thermally conductive casing, which helps to cool the batteries 102, and to form a secure battery pack. The casing includes a container for containing the assembly 100, and a lid for fitting to the container.

A method for assembling the battery assembly 100 is now briefly described.

Initially, as shown in FIG. 4, the assembly 100 with base plate 400 is provided. The batteries 102 are serially loaded between the posts 104 and into the receiver 402.

Next, with reference to FIG. 1, the plate receiver 106 receives the free ends of the posts 104 as it rests on the batteries 102.

Next, the locking plate 108 is placed over the posts 104 as shown in FIG. 2, and is then slid along the plate receiver 106 as shown in FIG. 3 so that the locking plate 108 engages with the retained posts 104 to lock the assembly 100 together.

The locked assembly 100 can then be securely placed in the casing to form the battery pack.

During recycling, the reverse disassembly steps can be readily performed to remove and replace the batteries 102.

The generally weld-free battery assembly 100, aside from electro-welded posts 104, eliminates fasteners without affecting the overall structure of the battery pack. It provides for quicker, easier assembly with less parts, and is designed for disassembly. The assembly 100 is safer to assemble and maintain, has reduced weight and size, and allows for any type of liquid cooling system.

A person skilled in the art will appreciate that many embodiments and variations can be made without departing from the ambit of the present invention.

In one embodiment, the base plate 400 and plate receiver 106 define physical molded in terminal bumps to promote electrical contact with the batteries 102.

In one embodiment, the electrical insulator plates 500, posts 104 and/or locking plate 108 are not polymeric. In one embodiment, the posts 104 are not electro-welded in place, but rather locked in place or secured by some other fixing method.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

What is claimed is:

1. A battery assembly, comprising:
batteries;
posts extending from the batteries;
a receiver for receiving the posts; and
a locking member for engaging with the received posts to lock the battery assembly together using a tongue-in-hole arrangement for engaging the locking member with the posts.

2. The battery assembly as claimed in claim 1, wherein the locking member defines apertures through which respective posts pass.

3. The battery assembly as claimed in claim 1, wherein the locking member can be slid along the receiver to engage the tongue-in-hole arrangement for locking.

4. The battery assembly as claimed in claim 1, wherein the locking member defines tongues which engage within holes in the posts.

5. The battery assembly as claimed in claim 1, wherein the receiver defines apertures through which respective posts are received.

6. The battery assembly as claimed in claim 1, wherein the receiver includes an insulator plate.

7. The battery assembly as claimed in claim 1, wherein the receiver includes a current collector for engaging with the batteries.

8. The battery assembly as claimed in claim 1, further comprising a base plate.

9. The battery assembly as claimed in claim 8, wherein the base plate includes an insulator plate.

10. The battery assembly as claimed in claim 8, wherein the base plate includes a current collector for engaging with the batteries.

11. The battery assembly as claimed in claim 8, wherein the posts extend from the base plate.

12. The battery assembly as claimed in claim 11, wherein the posts are welded to the base plate.

13. A battery pack, comprising:
the assembly as claimed in claim 1; and
a casing for encasing the assembly.

14. The battery pack as claimed in claim 13, wherein the casing includes a container, and a lid for fitting to the container.

15. A retainer for retaining batteries in a battery assembly, the retainer comprising:
posts for extending from the batteries;
a receiver for receiving the posts; and
a locking member for engaging with the received posts to lock the battery assembly together using a tongue-in-hole arrangement for engaging the locking member with the posts.

16. A method for assembling a battery assembly, the battery assembly including batteries and posts extending from the batteries, the method comprising:
receiving the posts with a receiver; and
engaging a locking member with the retained posts to lock the battery assembly together using a tongue-in-hole arrangement for engaging the locking member with the posts.

17. The method as claimed in claim 16, wherein engaging a locking member includes sliding the locking member along the receiver.

18. The method as claimed in claim 16, wherein engaging a locking member includes inserting one or more tongues in holes.

19. The method as claimed in claim 16, further comprising locating the batteries on a base plate from which the posts extend.
